(19) United States
(12) Patent Application Publication
(10) Pub. No.: US 2022/0024781 A1
(43) Pub. Date: Jan. 27, 2022

(54) FILTER DEVICE FOR FILTERING DRINKING WATER

(71) Applicant: KWC AG, Hergiswil (CH)

(72) Inventors: Manuel KEEL, Wildegg (CH); Markus LEUTWILER, Villmergen (CH)

(73) Assignee: KWC AG, Hergiswil (CH)

(21) Appl. No.: 17/297,018

(22) PCT Filed: Nov. 14, 2019
(86) PCT No.: PCT/EP2019/081366

§ 371 Date: May 26, 2021

(51) Int. Cl. C02F 1/00

(52) U.S. Cl. CPC C02F 1/003; C02F 2201/004; C02F 2201/006; C02F 2307/10

(57) ABSTRACT

A filter device for filtering drinking water, having a connection device on which a receiving part for connection of a filter cartridge is pivotably mounted. The receiving part has a wall which is at least sectionally rotationally symmetrical and forms a convex sliding surface at which inflow and return channels for water to be filtered that lead to a filter connection open. The wall bears sealingly against an inner wall, curved coaxially therewith, of the connection device, and connection openings for an inflow and return of the water to be filtered open out at the inner wall. The receiving part is pivotable into a working position, in which mouths of the inflow and return channels lie sealingly over the connection openings, and into a changeover position, in which the filter cartridge can be removed from and/or inserted into the receiving part, and the wall of the receiving part sealingly closes off the connection openings for the inflow and outflow of the water to be filtered.

### TECHNICAL FIELD

The present invention relates to a filter device for filtering drinking water.

### BACKGROUND

Filter devices are used in particular in households for treating and filtering water which is used for example for cooking, washing or for drinking. Here, filter devices may be arranged centrally, for example directly after the domestic water connection, but alternatively or additionally may also be arranged decentrally before a water discharge point, for example at a sink or washing machine. For the purpose of filtering drinking water, a filter cartridge is normally fitted in the filter device, in which filter cartridge the water flowing through is cleaned by means of one or more filter media. For example, in regions with hard water, filtering and reduction of the lime content can be an advantage for reducing or completely avoiding scale on sinks, cooking utensils or kitchen appliances.

From time to time, it is necessary to change the filter cartridge and replace it by a new one. This may be firstly for reasons of hygiene and secondly for reasons of efficiency in the filtering, since the filter medium can be depleted or clogged over time. For changing the filter cartridge, the feed and return lines must be shut off in order to prevent water flowing out. This may be realized by shut-off valves which can be actuated manually and which close off the water supply to the filter device. After the closure of the water supply, the filter cartridge can be removed from the filter device and replaced by a new filter cartridge. Afterwards, the shut-off valve must be opened again.

WO 2005/077490 A1 presents a filter device in which a filter cartridge is plugged onto corresponding connections on the filter device and is then locked by a pivotable cap. The pivoting movement of the cap results in a valve in the feed line being simultaneously opened or closed.

It is described in EP 2 366 442 A1 that a filter cartridge is mounted onto corresponding connections on the filter device and is arrested by way of a pivoting movement. A check valve is intended to prevent water from running out with a removed filter cartridge. It is not described how the check valve is however to be opened again after insertion of a new filter cartridge.

US 2016/0136547 A1 describes a filter device integrated into a refrigerator, in which the filter cartridge is plugged at an oblique angle into a receptacle in a rotatable cylinder and is then arrested by way of a pivoting movement. A mechanical noise indicates when the filter cartridge has reached the removal position. It is not described how the feed and return lines are shut off.

In particular in the case of a decentralized arrangement of the filter device before a water discharge point, changing the filter cartridge is difficult also due to limited space, for example in base cabinets or the like, since the filter device, also for aesthetic reasons, not freely accessible and not be fitted so as to be visible to everyone. Here, it is also a disadvantage that, for the actuation of shut-off valves which are situated in or behind for example kitchen cabinets, rearrangement or clearing-out is necessary for these. Moreover, after the shut-off valve, a relatively small line section, in which a corresponding water pressure still prevails, is still filled with water, such that, during the exchange of the filter cartridge, said water can escape from the filter device and makes the surrounding areas wet with water.

### SUMMARY

It is therefore an object of the invention to specify a filter device which overcomes the existing disadvantages in the prior art.

It is a further object of the invention to specify a filter device which makes possible a simple and secure changeover of a filter cartridge.

These and further objects are achieved by a filter device having one or more of the features disclosed herein. Preferred configurations of the filter device can be found below and in the claims.

According to the invention, the filter device for filtering drinking water comprises a connection device on which a receiving part for connection of a filter cartridge is pivotably mounted. The receiving part has a wall which is at least sectionally of rotationally symmetrical form and which forms a convex sliding surface at which inflow and return channels for the drinking water to be filtered that lead to a filter connection formed in the receiving part open out, wherein the wall bears sealingly against an inner wall, curved coaxially with respect thereto at least sectionally, of the connection device, and connection openings for an inflow and return of the drinking water to be filtered open out at the inner wall, and wherein the receiving part can be pivoted into a working position, in which the mouths of the inflow and return channels lie sealingly over the associated connection openings in the inner wall of the connection device, and into a changeover position, in which the filter cartridge can be removed from the receiving part or can be inserted into a connection opening of the filter connection in the receiving part and the wall of the receiving part sealingly closes off at least the connection opening for the inflow of the drinking water to be filtered.

The inner wall of the connection device and the wall of the receiving part are consequently formed in the shape of an arc about the pivot axis, as central axis, in the region of the sealing surface formed by the wall, with the result that, during a rotational movement of the receiving part relative to the inner wall of the connection device, the corresponding surfaces run one over the other and—possibly through the use of an additional seal—seal off with respect to one another. The pivoting movement results in at least the inflow being shut off, with the result that no water can exit the pressurized feed line when the filter cartridge is removed. Preferably, in the changeover position, both connection openings for the inflow and the return are closed off by the receiving part.

The filter device according to the invention allows a filter cartridge to be changed in a simple manner without interrupting the water feed line via a shut-off valve that is to be actuated manually, since the wall blocks the inflow and outflow of the drinking water to be filtered. The closure via the wall of the receiving part of the connection openings for the inflow and the outflow of the drinking water to be filtered makes it possible for the connection openings to be arranged at a fixed position in the filter device. The number of movable elements and in particular co-movable elements such as flexible tubes is thus reduced significantly. Moreover, the filter device can be of compact design since no further elements for blocking the inflow and outflow are required and both the inflow and the outflow of the drinking water are sealed off with the pivoting movement.

In a preferred embodiment, during a pivoting movement of the receiving part from the changeover position into the working position, the filter cartridge performs a movement into the filter receptacle in the receiving part in the insertion direction. The filter cartridge is sealed off by way of this movement into the receiving part at the filter connection, said movement being axial with respect to the longitudinal axis of the filter cartridge and radial with respect to the pivot axis.

Preferably, at least one guideway is formed in the connection device laterally with respect to the receiving part in such a way that, during the movement of the receiving part from the changeover position into the working position, a guide element arranged on the filter cartridge engages into the guideway. In this way, unintentional displacement of the filter cartridge in the connection device is prevented. Moreover, as soon as the guide elements have engaged into the guideway, the filter cartridge is supported in its position and can no longer fall out of the filter device unintentionally.

The guideway is preferably formed in such a way that, during a pivoting movement of the receiving part from the changeover position into the working position, the filter cartridge performs a pulling-in movement into the receiving part. The filter cartridge is thereby fixed to and sealed off at the filter connection of the receiving part. Moreover, the filter cartridge can only be mounted into the filter connection, and is fixed to the filter connection by way of the pulling-in movement via the guideway.

In a preferred embodiment, on both sides of the receiving part, in each case one guideway is formed in the connection device is. In this way, during the pivoting from the changeover position into the working position, the filter cartridge is supported on both sides, and jamming thereof can be avoided.

In a further preferred embodiment, in the region of an end position, the guideway has a depression in which the guide element latches in the end position. The filter cartridge is then secured in its end position, that is to say the working position, against sliding out or opening.

Preferably, the receiving part comprises at least one guide rail, which supports the filter cartridge during removal and insertion in the insertion direction. The filter cartridge can be placed onto the guide rail and pushed into the filter receptacle of the receiving part along said guide rail. Optionally, the guide rail may also be formed to be removable. For use of different filter cartridges, the guide rail can then be removed and replaced by a further guide rail, which is formed such that it corresponds to the contour of the filter cartridge.

In a further preferred embodiment, the wall is in the form of a cylindrical surface or spherical surface. In addition, any other rotationally symmetrical shape comes into consideration—for example a barrel shape or dumbbell shape.

Alternatively or in combination, on the connection device, there is arranged at least one locking element, which, in the changeover position, blocks a pivoting movement of the receiving part and which, by way of at least one engagement element on the filter cartridge, can be released during insertion of the filter cartridge. Due to the at least one locking element, a movement of the receiving part without filter cartridge, whereby the connection openings are connected fluidically and the feed line is thereby opened unintentionally, is prevented. This, too, ensures that, at all times, there is inserted a filter cartridge for cleaning the drinking water.

Preferably, on both sides of the receiving part, at least one locking element is arranged on the connection device or the receiving part. In this way, one-sided rotation of the receiving part is prevented and at the same time the secureness is increased, since at least two locking elements have to be released.

In a further preferred embodiment, the locking elements are arranged offset in height and/or depth with respect to one another or differ in terms of their form. The arrangement of locking elements, which are moreover offset from one another, increases the secureness such that unintentional pivoting of the receiving part is prevented.

Alternatively or in combination, the receiving part can be pivoted from the working position into the changeover position through an angle of less than 90°, preferably through an angle of between 30° and 60°, particularly preferably of between 45° and 60°. In this way, the filter cartridge can be changed in a simple and handy manner without great expenditure of force.

Preferably, at least one first seal is arranged on the inner wall around the connection openings and seals off the connection openings with respect to the wall. In particular the connection opening for the drinking-water feed line to the filter device is sealed off securely. The flow of the drinking water via the filter device is consequently interrupted in a drip-proof manner.

A further preferred embodiment of the filter device is distinguished in that at least one second seal is arranged on the inner wall and seals off the mouths of the inflow and return channels with respect to the inner wall during the pivoting movement of the receiving part outside the working position. The sealing-off of the mouths of the inflow and return channels prevents drinking water still contained therein from being able to drip out of these during the changeover of the filter cartridge. Here, the second seal may also in particular be integrated with the first seal to form a so-called two-chamber seal.

Preferably, on the filter cartridge, there is arranged at least one securing element for securing the filter cartridge in the working position is. In particular, the securing element prevents rotation of the filter cartridge about the longitudinal axis thereof. Thus, the filter cartridge, in the working position, cannot be rotated and is firmly seated in the filter device. This is advantageous since users not entrusted with the handling could attempt to release the filter cartridge by rotation. Such misuse, which could lead to damage or unscrewing of the filter cartridge itself, is prevented by a rotation-prevention means. Particularly with the use of filter cartridges in which the filter medium can be changed, it is ensured via the securing element that the housing of the filter cartridge cannot be opened in the working position. The securing elements may preferably be in the form of studs, elongate fixtures and/or strips.

### BRIEF DESCRIPTION OF THE DRAWINGS

Further advantages and properties of the present invention will be discussed below on the basis of drawings and an exemplary embodiment.

In the drawings:

FIG. 1 shows, in a side view, a filter device according to the invention with an inserted filter cartridge in the working position;

FIG. 2 shows a side view of a filter device according to the invention in the changeover position;

FIG. 3 shows an isometric view of the connection device without the pivotable connection part thereof;

FIG. 4 shows a plan view of the connection device from FIG. 3;

FIG. 5 shows a section through the filter device in the working position;

FIG. 6 shows a section through the filter device in the changeover position;

FIG. 7 shows a section through the filter device in the working position along the central axis thereof;

FIG. 8 shows a section through the filter device in the changeover position along the central axis thereof;

FIG. 9 shows a side view of the filter device during insertion of the filter cartridge, and

FIG. 10 shows an isometric view of the head region of a filter cartridge.

### DETAILED DESCRIPTION

FIG. 1 illustrates a filter device 1 for filtering drinking water in the working position A, in which a filter cartridge 20 is inserted in the filter device 1. The filter device 1 comprises a connection device 2, at which the connections 3 for the drinking-water feed and discharge lines open out. The connections 3 are positionally fixed and lead via channels to connection openings 4 in the inner wall 9 of the connection device 2. Furthermore, a receiving part 10 is arranged on the connection device 2, which receiving part can be pivoted about a pivot axis 19 from the working position A into the changeover position B. The receiving part 10 serves for receiving a filter cartridge 20 in which the drinking water is filtered. The filter cartridge 20 may for example be a lime filter for decalcification of the drinking water. Other filters, such as cleaning filters, such as activated-carbon filters, nonwoven filters, diaphragm filters or the like, may however also be inserted into the filter device 1. The receiving part 10 comprises a lower guide rail 11, which serves for guiding the filter cartridge 20 during insertion into the filter device 1 and makes possible simple handling during the changeover of the filter cartridge 20. Beside the lower guide rail 11, an upper guide rail 12 may also be arranged on the receiving part 10, which further improves the handling. A guide element 22 in the form of a pin is attached to the filter cartridge 20 laterally on both sides and can engage into a guideway 8 of the connection device 2. In the working position A, the filter cartridge 20 is supported in the guideway via the guide element 8 and the filter cartridge 20 is prevented from falling out of the receiving part 10 during operation.

At the end of the guideway 8, the guide element 22, in its end position, latches into a type of eye 8a. Here, said eye is a depression 8a serving as an arresting aid in the guideway 8 and in which the guide element 22 latches in the end position. The filter cartridge 20 is then secured in its end position, that is to say the working position, against sliding out or opening. For the purpose of opening, the filter cartridge must firstly be raised slightly before the receiving part 10 can be pivoted into the changeover position. Thus, as a result of the depression 8a in the guideway, a stable end position is achieved and the filter cartridge is secured against inadvertent opening, for example as a result of vibrations.

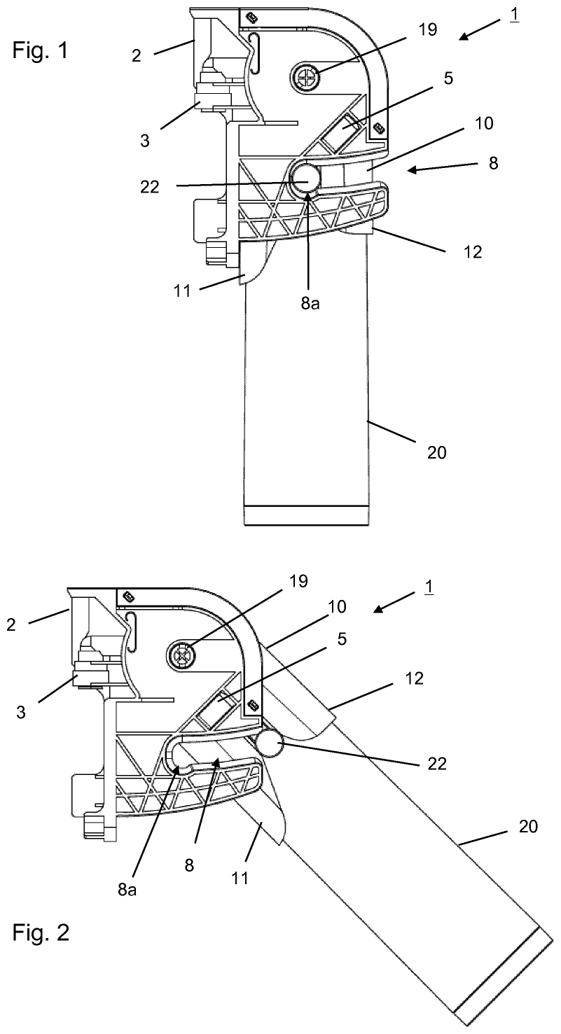

For the purpose of changing the filter cartridge 20, the filter device is transferred from a working position A into a changeover position B, which is illustrated in FIG. 2. For the purpose of switching from the working position A into the changeover position B, the receiving part 10 is pivoted through an angle of less than 90°, preferably of between 30° and 60°, in order for the filter cartridge 20 to be removed in a user-friendly manner. In the changeover position B, the guide elements 22 no longer engage into the guideway 8, with the result that the filter cartridge 20 can be removed easily from the receiving part 10 and a new filter cartridge 20 can be inserted. The secure insertion and removal of the filter cartridge 20 is ensured via the guide rails 11, 12. Moreover, the guide rails 11, 12 may form and another guide or a stop in the receiving part 10 for the filter cartridge 20, which guide or stop interacts with the guide element 22. For the purpose of using different filter cartridges 20, the guide rails 11, 12 may also be exchangeable, with the guide rails 11, 12 being formed according to the contour of the filter cartridge 20.

In the changeover position B, the receiving part 10 is arrested in a fixed position via locking elements 5 such as for example a latching nose on the connection device 2. The arresting prevents pivoting of the receiving part 10 into the working position A, in which the connection openings 4 are opened up again, without a filter cartridge 20 being inserted. The locking of the receiving part 10 via the locking elements 5 is released by engagement elements 23 on the filter cartridge 20 during insertion of the filter cartridge 20, for example in that the respective locking nose is held back and can no longer latch in at the receiving part 10.

Advantageously, at least in each case one locking element 5 is arranged laterally with respect to the receiving part 10, and the corresponding number of engagement elements 23 are provided on the filter cartridge 20. Offsetting of the locking elements 5 in height and/or depth with respect to one another results in the secureness being increased further. Moreover, it can ensured in this way that the filter cartridge 20 is inserted correctly, since the engagement elements 23 must also be formed differently according to the locking elements 5. Alternatively, the locking elements 5 may also have a different form, said locking elements being released by correspondingly differently formed engagement elements 23.

After insertion of a new filter cartridge 20 in the changeover position B, the receiving part 10 is pivoted together with the filter cartridge 20 in order for these to be brought into the working position A. During the pivoting movement, the guide elements 22 on the filter cartridge 20 engage into the guideway 8. In this way, the filter cartridge 20 is supported and cannot fall out of the receiving part 10. Additionally, via the guideway 8, the filter cartridge 20 can be guided in such a way that, in addition to the pivoting movement, it performs an axial movement into the receiving part 10. Due to this “axial pulling-in”, that is to say the forced movement, brought about via the lateral guidance, of the filter cartridge 20 into the receptacle thereof in the insertion direction, said filter cartridge is pushed into the receiving part 10 and a secure and in particular sealed connection between receiving part 10 and filter cartridge 20 is achieved. During the movement from the working position A into the changeover position, the filter cartridge 20 performs the correspondingly reversed movement and is pushed out of the receiving part 10, with the result that said filter cartridge is easier to remove in the changeover position B.

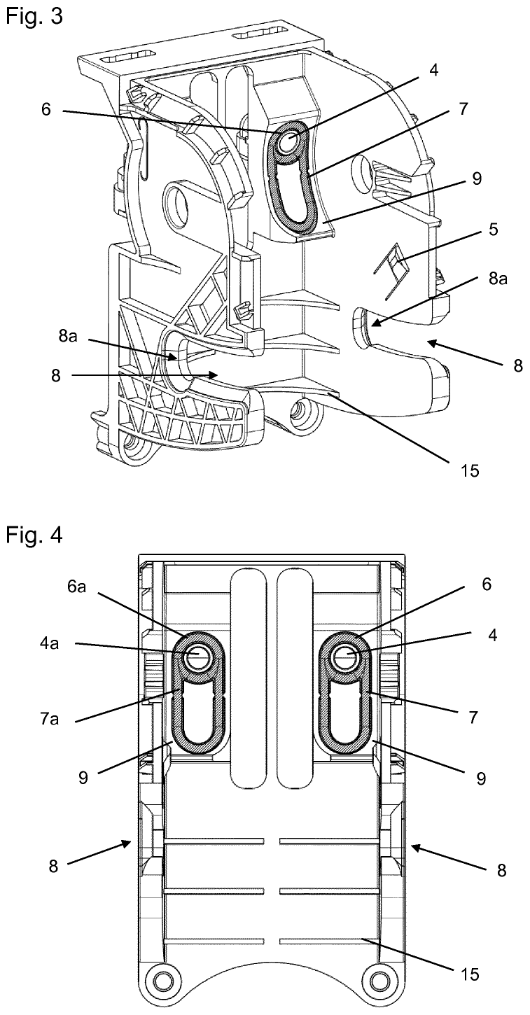

FIGS. 3 and 4 show a detailed illustration of the connection device 2. The connection opening 4 is arranged in the inner wall 9 of the connection device 2, which inner wall is of concave form. The form of the inner wall 9 around the connection openings 4 is coaxial with respect to the wall 13 of the receiving part 10, which wall bears sealingly against the inner wall 9. The inner wall 9 as well as the wall 13 are at least sectionally of rotationally symmetrical form, preferably in the form of a cylindrical or spherical surface. For the purpose of sealing the connection openings 4, at which the inflow and outflow of the drinking water to be filtered open out, the connection openings 4 are surrounded by a first seal 6. A second seal 7 lies in the inner wall 9 adjacent to the first seal 6 and encloses a more elongate region of the inner wall 9. Via the second seal 7, the mouths 18 of the inflow channel 16 and return channel 17 are sealed off with respect to the inner wall 9. It is thus also not possible during the pivoting of the receiving part 10 for any drinking water to flow or drip out of the inflow channel 16 and outflow channel 17, and so the surface below the filter device 1 remains dry at all times.

The plan view shown in FIG. 4 illustrates both connection openings 4, 4a, arranged in a laterally offset manner, for the inflow and the return. Each connection opening is in each case provided with a seal 6, 6a, and situated in each case therebelow is the second seal 7, 7a, which, in the changeover position, closes off the inflow channel 16 or the return channel 17 with respect to the inner wall 9.

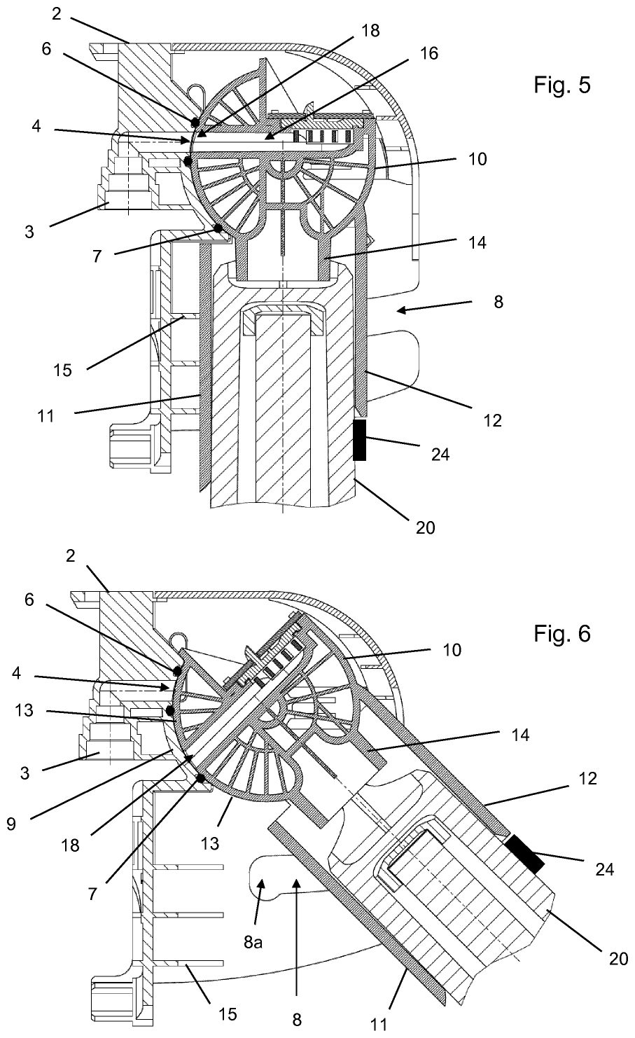

FIGS. 5 and 6 in each case illustrate a section through the filter device 1, in the working position A (FIG. 5) and in the changeover position B (FIG. 6). Here, the section plane extends through the connection openings 4, with the result that the inflow channel 16 can be seen. In the working position A, the connection 3 for the inflow and for the return of the drinking water are connected fluidically to the filter cartridge 20 via the connection opening 4 and the inflow channel 16 and return channel 17. Here, the seal 6 seals off the transition between connection opening 4 and the mouths 18 of the inflow channel 16 and of the return channel 17. The filter cartridge 20 is seated in a filter receptacle 14 in the receiving part 10 and is surrounded on both sides by the guide rails 11, 12. In the working position A, the guide rail 11 bears against stop elements 15, with the result that the mouths 18 of the inflow channel 16 and return channel 17 are at the same height as the connection openings 4. The inner wall 9 of the connection device 2 and the wall 13 of the receiving part are formed to be coaxial with respect to one another, with the result that, during a movement of the receiving part 10, the wall 13 slides along the inner wall 9. Preferably, the wall 13 and the inner wall 9 in each case have, at least sectionally, a cylindrical shape.

In the changeover position B, which is illustrated in FIG. 5, the fluidic connection between the connection opening 4 and the inflow channel 16 and return channel 17 is interrupted. The connection opening 4 is sealed off via the wall 13 of the receiving part and the first seal 6, with the result that flowing-out of water at the still prevailing water pressure is not possible. Disconnection of the water supply by way of slides or valves is therefore not necessary. Beside the sealing of the connection openings 4, in the changeover position, the mouths 18 of the inflow and return channels 16, 17 are also sealed off with respect to the inner wall 9 by means of the seal 7. Thus, here too, can water can escape. With the movement of the receiving part 10 from the working position A into the changeover position B, the filter cartridge 20 is pushed out of the filter receptacle 14, with the result that said filter cartridge is easier to remove. After insertion of a new filter cartridge 20, the latter, supported by the engagement and the movement of the guide element 22 in the guideway 8, is pulled into the filter receptacle 14. As a result of this axial into the filter receptacle 14, which is an additional movement along with the pivoting movement, the filter cartridge 20 is sealed off in the filter receptacle 14.

It is moreover possible for securing elements 24 to be arranged on the filter cartridge 20, which prevent movement of the filter cartridge 20 in the working position. In particular, the securing elements 24 make it possible to prevent rotation of the filter cartridge 20. In particular in the case of filter cartridges 20 which are accommodated in a separate, reusable filter housing with a screwed-on filter head, inadvertent opening of the housing of the filter cartridge 20 about the longitudinal axis thereof is consequently prevented.

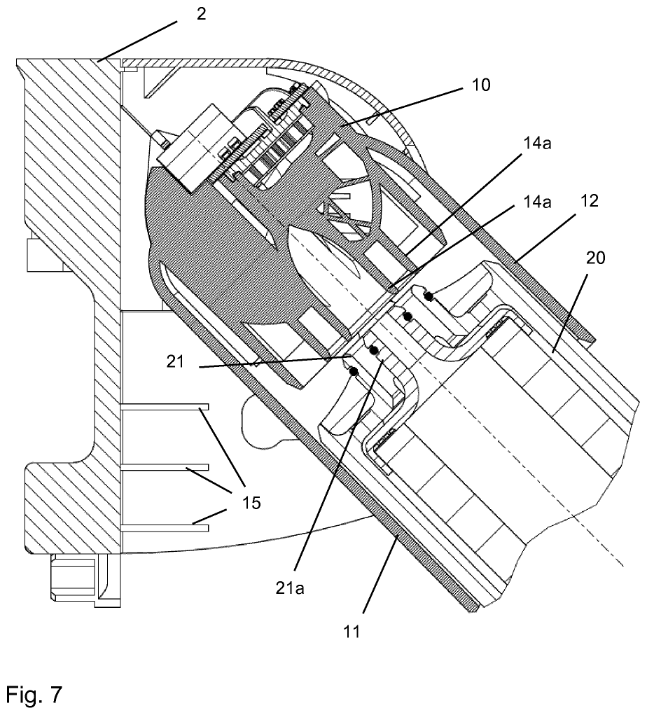

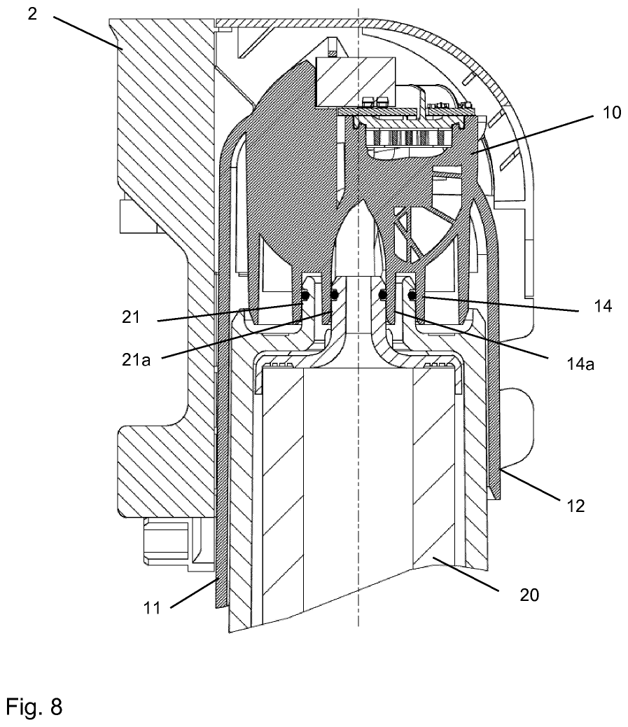

FIGS. 7 and 8 likewise show sections through the filter device 1 in the working position A (FIG. 7) and in the changeover position B (FIG. 8). However, here, the section plane extends along the central line of the connection device 2, and so the details of the coupling between the filter cartridge 20 and the receiving part 10 can be seen. Said coupling is realized via the filter connection 14 arranged on the receiving part 10, on the one hand, and via a suitably formed connection piece 21 on the filter cartridge 20, on the other hand.

Due to the shaping of the guideway 8, the filter cartridge 20 and the connection piece 21 thereof are, in the changeover position shown in FIG. 7, situated slightly away from the filter connection 14 in the connection part 10 and are not yet connected fluidically thereto. During the pivoting of the receiving part 10 into the working position shown in FIG. 8, the filter cartridge 20, as already explained, is displaced against the filter connection 14, with the result that the connection piece 21 is pushed sealingly into the filter connection 14. Here, there is formed a fluid-tight connection between the inflow channel 16 via an outer annular region of the filter connection 14 to an outer region, likewise formed as an annular space, of the connection piece 21, on the one hand, and from the return channel 17 via an inner region 14a of the filter connection 14 to an inner region 21a of the connection piece 21, on the other hand. Consequently, water flows through the filter-active layers of the cylindrical filter cartridge from the outside inward. Both in the inflow-side connection region, the annular space of the connection piece 21, and in the return-side connection region, the inner region 21a of the connection piece 21, there is provided in each case one separate seal.

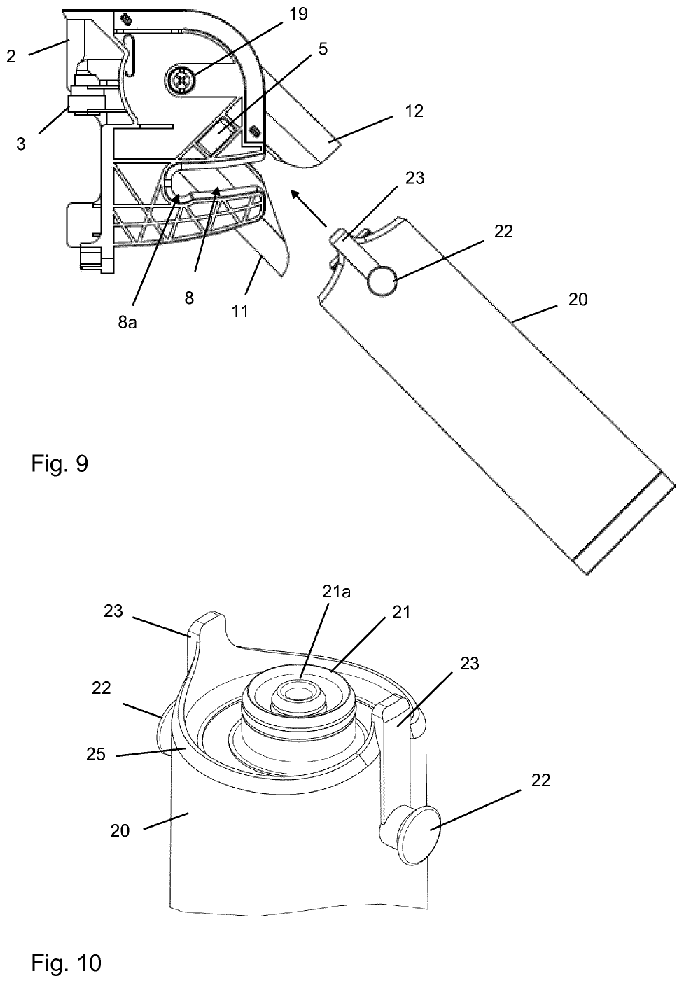

FIG. 9 shows the insertion of a filter cartridge 20 into the connection device 2. The connection device 2 is in the changeover position and is arrested on both sides by the locking elements 5. The filter cartridge is inserted in a longitudinal direction, as indicated by the arrow, along the guide rails 11, 12. In the process, the two engagement elements 23 arranged laterally on the head of the filter cartridge enter the gap between connection device 2 and receiving part 10 and force the locking element 5 back, with the result that the receiving part 10 can be rotated about the pivot axis 19 within the connection device 2. The filter cartridge 20 can then be pivoted, together with the receiving part 10, into the working position shown in FIG. 1, wherein the lateral guide elements 22 engage into the guideway 8 and guide the filter cartridge 20 against the filter connection 14 formed in the receiving part 10. Finally, in the end position, the guide element 22 latches in the depression 8a of the guideway 8—the filter cartridge is locked in the connection device and is connected to a feed line and discharge line.

Finally, FIG. 10 illustrates on an enlarged scale the upper region of the filter cartridge 20 with the connection piece 21. Water to be filtered enters the housing of the filter cartridge through the outer, annular region of the connection piece 21, passes through the filter-active layers situated in the filter and exits again at the inner region 21a of the connection piece 21. On both sides of the filter cartridge are arranged the guide elements 22, each in the form of a mushroom-type pin, and the engagement elements 23, each in the form of an upwardly pointing tongue, by way of which the locking elements 5 are unlocked during insertion of the filter cartridge 20. It can also be seen in the figure that the outer boundary 25 of the housing of the filter cartridge 20 is upturned so as to form a type of pot around the connection piece 21. This serves as a collecting reservoir for any residual water exiting during the removal or exchange of the filter cartridge.

1. A filter device (1) for filtering drinking water, comprising:
a connection device (2) on which a receiving part (10) for connection of a filter cartridge (20) is pivotably mounted,
the receiving part (10) has a wall (13) which is at least sectionally of rotationally symmetrical form and which forms a convex sliding surface at which inflow and return channels (16, 17) for the drinking water to be filtered that lead to a filter connection (14) formed in the receiving part (10) open out,
the wall (13) bears sealingly against an inner wall (9) of the connection device, the inner wall being curved coaxially with respect the wall at least sectionally, and connection openings (4) for an inflow and return of the drinking water to be filtered open out at the inner wall (9), and
the receiving part (10) is pivotable into a working position (A), in which mouths (18) of the inflow and return channels (16, 17) lie sealingly over associated ones of the connection openings (4) in the inner wall (9) of the connection device (2), and into a changeover position (B), in which the filter cartridge (20) is removable from the receiving part (10) or is insertable into an opening of the filter connection (14) in the receiving part (10), and the wall (13) of the receiving part (10) sealingly closes off at least the connection opening (4) for the inflow of the drinking water to be filtered.

2. The filter device (1) as claimed in claim 1, wherein during a pivoting movement of the receiving part (10) from the changeover position (B) into the working position (A), the filter cartridge (20) performs a movement into the filter connection (14) in the receiving part (10) in an insertion direction.

3. The filter device (1) as claimed in claim 1, further comprising a guide element (22) arranged on the filter cartridge, and at least one guideway (8) formed in the connection device (2) laterally with respect to the receiving part (10) such that, during the movement of the receiving part (10) from the changeover position (B) into the working position (A), the guide element (22) arranged on the filter cartridge (20) engages into the guideway (8).

4. The filter device (1) as claimed in claim 3, wherein the guideway (8) is configured such that, during the pivoting movement of the receiving part (10) from the changeover position (B) into the working position (A), the filter cartridge (20) performs a pulling-in movement into the receiving part (10).

5. The filter device (1) as claimed in claim 3, wherein on both sides of the receiving part (10), in each case one of the guideways (8) is formed in the connection device (2).

6. The filter device (1) as claimed in claim 3, wherein in a region of an end position, the guideway (8) has a depression (8a) in which the guide element (22) latches in the end position.

7. The filter device (1) as claimed in claim 1, wherein the receiving part (10) comprises at least one guide rail (11, 12) for supporting the filter cartridge (20) in an insertion direction.

8. The filter device (1) as claimed in claim 1, wherein the wall (13) comprises a cylindrical surface or spherical surface.

9. The filter device (1) as claimed in claim 1, wherein on the connection device (2), there is arranged at least one locking element (5), which, in the changeover position (B), blocks a pivoting movement of the receiving part (10) and which, by way of at least one engagement element (23) on the filter cartridge (20), is releasable during insertion of the filter cartridge (20).

10. The filter device (1) as claimed in claim 9, wherein one of the locking elements (5) is located on each side of the receiving part (10), the locking elements (5) being arranged on the connection device (2) or the receiving part.

11. The filter device (1) as claimed in claim 10, wherein the locking elements (5) are arranged offset in a height or depth with respect to one another or differ in form.

12. The filter device (1) as claimed in claim 1, wherein the receiving part (10) is pivotable from the working position (A) into the changeover position (B) through an angle of less than 90°.

13. The filter device (1) as claimed in claim 1, further comprising at least one first seal (6) arranged on the inner wall (9) around the connection openings (4) that seals off the connection openings (4) with respect to the wall (13).

14. The filter device (1) as claimed in claim 13, further comprising at least one second seal (7) arranged on the inner wall (9) that seals off the mouths (18) of the inflow and return channels (16, 17) with respect to the inner wall (9) during the pivoting movement of the receiving part (10) outside the working position (A).

15. The filter device (1) as claimed in claim 1, further comprising at least one securing element (24) arranged on the filter cartridge for securing the filter cartridge (20) in the working position (A) against rotation of the filter cartridge (20) about a longitudinal axis thereof.
